(19) United States
(12) Patent Application Publication
(10) Pub. No.: US 2023/0036830 A1
(43) Pub. Date: Feb. 2, 2023

(54) NON-AQUEOUS ELECTROLYTE SECONDARY BATTERY

(71) Applicant: SANYO Electric Co., Ltd., Kadoma-shi, Osaka (JP)

(72) Inventor: Atsushi Obayashi, Hyogo (JP)

(73) Assignee: SANYO Electric Co., Ltd., Kadoma-shi, Osaka (JP)

(21) Appl. No.: 17/787,785

(22) PCT Filed: Dec. 15, 2020
(86) PCT No.: PCT/JP2020/046644

§ 371 Date: Jun. 21, 2022

(30) Foreign Application Priority Data
Dec. 25, 2019 (JP) 2019-233767

(51) Int. Cl. H01M 10/0567; H01M 10/0568; H01M 4/13

(52) U.S. Cl. CPC H01M 10/0567; H01M 10/0568; H01M 4/13; H01M 2004/021

(57) ABSTRACT

This non-aqueous electrolyte secondary battery comprises: an electrode assembly in which a positive electrode and a negative electrode are laminated via a separator; and a non-aqueous electrolyte. The non-aqueous electrolyte includes an SO₂ bond-containing lithium salt and an isocyanate group-containing compound. With respect to the mass of the non-aqueous electrolyte, the concentration of the lithium salt is preferably 0.1-2.5 mass % and the concentration of the compound is preferably 0.1-8 mass %.

### TECHNICAL FIELD

The present disclosure generally relates to a non-aqueous electrolyte secondary battery.

### BACKGROUND ART

Conventionally, a known fact regarding non-aqueous electrolyte secondary batteries such as lithium-ion batteries is that a metal foreign matter entering an electrode assembly causes a minute short-circuit. When the metal foreign matter enters the electrode assembly, the metal foreign matter is oxidatively dissolved on a positive electrode side, for example. The eluted metal ion, which has a positive charge, moves to a negative electrode side, and reductively precipitates on a negative electrode surface to form a needle precipitation called a dendrite. The dendrite grows to penetrate a separator and form a conductive path between the positive and negative electrodes due to the dendrite, leading to the minute short-circuit.

In order to prevent such a short circuit, considered are a method in which an amount of the entering metal foreign matter is strictly managed (preventive method) and a method in which the influence of the entered metal foreign matter is relaxed (rendering harmless method). Proposed as one of the rendering harmless technique of the metal foreign matter is a method in which a separator having a specifically layered structure is used to regulate a gas permeation degree in the thickness direction and surface direction of each layered structure, and in addition, a negative electrode potential is applied to some conductive layers to perform a minute charge with a low rate in a long time (see Patent Literature 1).

### CITATION LIST

### Patent Literature

PATENT LITERATURE 1: Japanese Unexamined Patent Application Publication No. 2014-099275

### SUMMARY

According to the method disclosed in Patent Literature 1, the entered metal foreign matter may be dispersed and precipitated; however, the separator having a regulated gas permeation degree is expensive. In addition, a mechanism for applying the negative electrode potential is required to be provided inside the battery to perform the minute charge in a long time, leading to a problem of productivity. An object of the present disclosure is to inhibit an occurrence of the minute short-circuit caused by the metal foreign matter entered in the electrode assembly without impairing the battery productivity and battery performances such as output characteristics.

A non-aqueous electrolyte secondary battery according to the present disclosure is a non-aqueous electrolyte secondary battery, comprising: an electrode assembly in which a positive electrode and a negative electrode are stacked with a separator interposed therebetween; and a non-aqueous electrolyte, wherein the non-aqueous electrolyte includes a lithium salt (A) containing an SO₂ bond and a compound (B) containing an isocyanate group. In the non-aqueous electrolyte secondary battery according to the present disclosure, a mixture layer of the negative electrode preferably has a porosity of 35% to 50%.

The non-aqueous electrolyte secondary battery according to the present disclosure may inhibit an occurrence of the minute short-circuit caused by the metal foreign matter without impairing the battery productivity and battery performances such as output characteristics. If a metal foreign matter enters the electrode assembly, the non-aqueous electrolyte secondary battery according to the present disclosure may sufficiently relax the influence of the metal foreign matter, and prevent a formation and growth of a dendrite on a negative electrode surface.

### BRIEF DESCRIPTION OF DRAWINGS

FIG. 1 is a perspective view illustrating an appearance of a non-aqueous electrolyte secondary battery of an example of an embodiment.

FIG. 2 is a perspective view of an electrode assembly of an example of an embodiment.

FIG. 3 is a sectional view of an electrode assembly of an example of an embodiment.

### DESCRIPTION OF EMBODIMENTS

The present inventor has made intensive investigation to prevent an occurrence of the minute short-circuit caused by the metal foreign matter, and as a result, has successfully inhibited a growth of the dendrite on the negative electrode surface by a simple method in which two specific compounds are added into a non-aqueous electrolyte. The two compounds added into the non-aqueous electrolyte (a lithium salt (A) containing an SO₂ bond and a compound (B) containing an isocyanate group) are considered to enhance an oxidative elution of the metal foreign matter on the positive electrode and to inhibit a reductive precipitation of the eluted metal ion on the negative electrode. The enhancement of the oxidative elution of the metal foreign matter enables all the metal foreign matter to be eluted before the product is marketed, for example in an inspection process in a battery assembling process. In particular, a function of the SO₂ bond-containing lithium salt (A) is considered to enhance the oxidative elution of the metal foreign matter, and a function of the isocyanate compound (B) is considered to delay the precipitation of the eluted ion on the negative electrode.

Regulating a porosity and pore diameter of a negative electrode mixture layer within a specific range may further inhibit the formation and growth of the dendrite to more certainly prevent the occurrence of the minute short-circuit caused by the metal foreign matter. It is to be noted that adding a large amount of the isocyanate compound (B) causes a trade-off phenomenon between an enlarged inhibition effect of the reductive precipitation of the metal ion and a deteriorated input-output characteristics of the battery. Similarly, adding a large amount of the SO₂ bond-containing lithium salt (A) causes a trade-off phenomenon between an enlarged enhancement effect of the oxidative elution and a contribution to improvement in input-output characteristics and an enlarged amount of generation gas during a storage at high temperature.

Adding the SO₂ bond-containing lithium salt (A) and the isocyanate compound (B) into the non-aqueous electrolyte and regulating the porosity and pore diameter of the negative electrode mixture layer within the specific range may prevent the occurrence of the minute short-circuit caused by the metal foreign matter with inhibiting the deterioration of input-output characteristics and increase in the amount of generation gas during a storage at high temperature.

Hereinafter, an example of an embodiment of a non-aqueous electrolyte secondary battery according to the present disclosure will be described in detail with reference to the drawings. It is anticipated in advance to selectively combine a plurality of embodiments and modified examples exemplified below. The description “a numerical value A to a numerical value B” herein means “the numerical value A or more and the numerical value B or less”, unless otherwise specified.

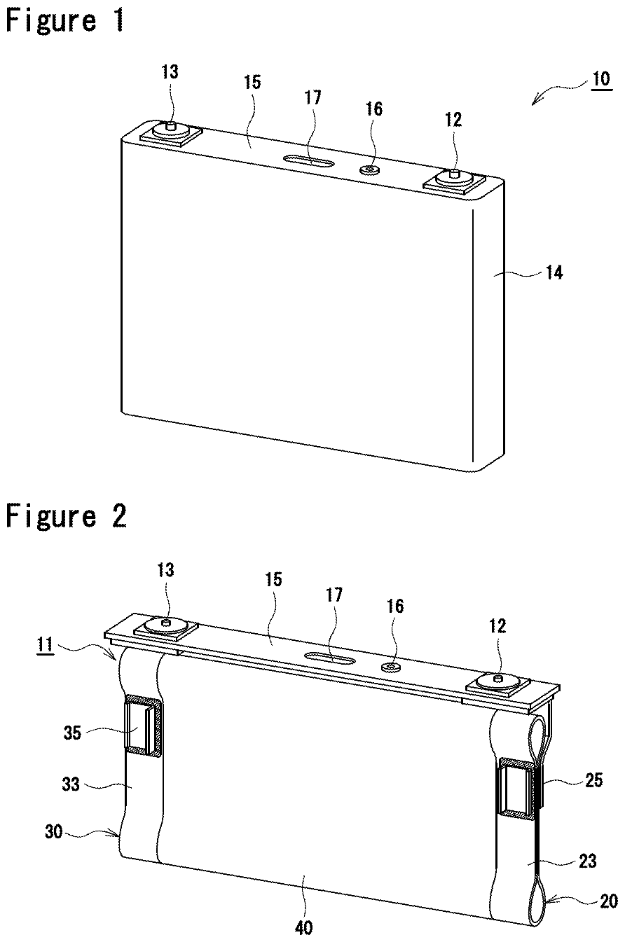

FIG. 1 is a perspective view illustrating an appearance of a non-aqueous electrolyte secondary battery 10 of an example of an embodiment. FIG. 2 is a perspective view of an electrode assembly 11 constituting the non-aqueous electrolyte secondary battery 10. The non-aqueous electrolyte secondary battery 10 illustrated in FIG. 1 comprises a bottomed rectangular-cylindrical exterior housing can 14 as an exterior housing body, but the exterior housing body is not limited thereto. The non-aqueous electrolyte secondary battery according to the present disclosure may be, for example, a cylindrical battery comprising a bottomed cylindrical exterior housing can, a coin battery comprising a coin-shaped exterior housing can, or a laminate battery comprising an exterior housing body constituted with a laminated sheet including a metal layer and a resin layer.

As illustrated in FIG. 1 and FIG. 2, the non-aqueous electrolyte secondary battery 10 comprises: the electrode assembly 11; a non-aqueous electrolyte; the bottomed rectangular-cylindrical exterior housing can 14 housing the electrode assembly 11 and the non-aqueous electrolyte; and a sealing plate 15 sealing an opening of the exterior housing can 14. The non-aqueous electrolyte secondary battery 10 is a so-called rectangular battery. The electrode assembly 11 has a wound structure in that a positive electrode 20 and a negative electrode 30 are wound with a separator 40 interposed therebetween. Any of the positive electrode 20, the negative electrode 30, and the separator 40 is a band-shaped elongate body, and the positive electrode 20 and the negative electrode 30 are stacked with the separator 40 interposed therebetween to be wound on the winding axis.

The electrode assembly may be a stacked electrode assembly in which a plurality of positive electrodes and a plurality of negative electrodes are alternately stacked one by one with a separator interposed therebetween.

The non-aqueous electrolyte secondary battery 10 comprises: a positive electrode terminal 12 electrically connected to the positive electrode 20 with a positive electrode current collector 25 interposed therebetween; and a negative electrode terminal 13 electrically connected to the negative electrode 30 with a negative electrode current collector 35 interposed therebetween. In the present embodiment, the sealing plate 15 has an elongate rectangular shape, and the positive electrode terminal 12 is disposed on one end side in the longitudinal direction of the sealing plate 15, and the negative electrode terminal 13 is disposed on the other end side in the longitudinal direction of the sealing plate 15. The positive electrode terminal 12 and the negative electrode terminal 13 are external connection terminals to be electrically connected to another non-aqueous electrolyte secondary battery 10, each electronic device, and the like, and attached to the sealing plate 15 with an insulating member interposed therebetween.

Hereinafter, for convenience of description, the height direction of the exterior housing can 14 will be described as “the upper-lower direction” of the non-aqueous electrolyte secondary battery 10, the sealing plate 15 side will be described as “the upper side”, and the bottom side of the exterior housing can 14 will be described as “the lower side”. The direction along the longitudinal direction of the sealing plate 15 will be described as “the lateral direction” of the non-aqueous electrolyte secondary battery 10.

The exterior housing can 14 is a bottomed rectangular-cylindrical metal container. An opening formed on the upper end of the exterior housing can 14 is sealed by, for example, welding the sealing plate 15 with an edge part of the opening. Provided on the sealing plate 15 are typically a liquid injecting part 16 for injecting the non-aqueous electrolyte liquid, a gas discharging vent 17 to open and discharge gas with abnormality in battery, and a current-cutting mechanism, not illustrated. The exterior housing can 14 and the sealing plate 15 are constituted with, for example, a metal material mainly composed of aluminum.

The electrode assembly 11 is a flat, wound electrode assembly including a flat part and a pair of curved parts. The electrode assembly 11 is housed in the exterior housing can 14 in a state where the winding axial direction is along the lateral direction of the exterior housing can 14, and the width direction of the electrode assembly 11 with aligning the pair of the curved parts is along the height direction of the battery. In the present embodiment, a current collecting part on the positive electrode side in which a core exposed part 23 of the positive electrode 20 is stacked is formed on one end part in the axial direction of the electrode assembly 11, and a current collecting part on the negative electrode side in which a core exposed part 33 of the negative electrode 30 is stacked is formed on the other end part in the axial direction. Each current collecting part is electrically connected to a terminal with a current collector interposed therebetween. An insulating electrode assembly holder (insulating sheet) may be interposed between the electrode assembly 11 and an internal surface of the exterior housing can 14.

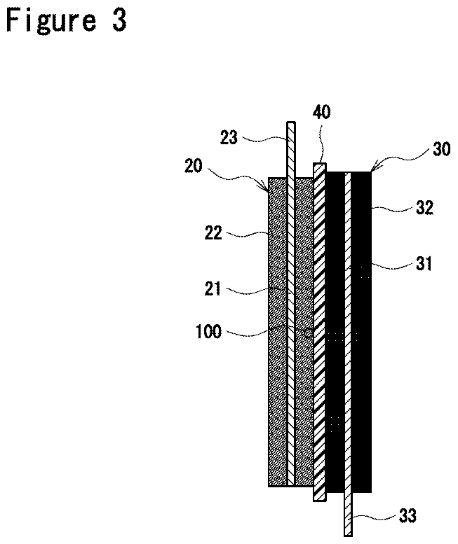

Hereinafter, the positive electrode 20, the negative electrode 30, and the separator 40, which constitute the electrode assembly 11, particularly the negative electrode 30, will be described in detail with reference to FIG. 3. The non-aqueous electrolyte will also be described in detail. FIG. 3 illustrates a state where a metal foreign matter 100 enters between the positive electrode 20 and the separator 40.

### Positive Electrode

As illustrated in FIG. 3, the positive electrode 20 has a positive electrode core 21 and a positive electrode mixture layer 22 formed on a surface of the positive electrode core 21. For the positive electrode core 21, a foil of a metal stable within a potential range of the positive electrode 20, such as aluminum and an aluminum alloy, a film in which such a metal is disposed on a surface layer thereof, and the like may be used. The positive electrode mixture layer 22 includes a positive electrode active material, a conductive agent, and a binder, and is preferably formed on both surfaces of the positive electrode core 21. In the present embodiment, the core exposed part 23 where a surface of the core is exposed along the longitudinal direction is formed on one end part in the width direction of the positive electrode 20. The positive electrode 20 may be produced by, for example, applying a positive electrode mixture slurry including the positive electrode active material, the conductive agent, the binder, and the like on the positive electrode core 21, drying and subsequently compressing the applied film to form the positive electrode mixture layers 22 on both the surfaces of the positive electrode core 21.

For the positive electrode active material, a lithium-transition metal composite oxide is used. Examples of metal elements contained in the lithium-transition metal composite oxide include Ni, Co, Mn, Al, B, Mg, Ti, V, Cr, Fe, Cu, Zn, Ga, Sr, Zr, Nb, In, Sn, Ta, and W. Among them, at least one of the group consisting of Ni, Co, and Mn is preferably contained. A preferable example of the composite oxide is a lithium-transition metal composite oxide containing Ni, Co, and Mn, or a lithium-transition metal composite oxide containing Ni, Co, and Al.

Examples of the conductive agent included in the positive electrode mixture layer 22 may include a carbon material such as carbon black, acetylene black, Ketjenblack, and graphite. Examples of the binder included in the positive electrode mixture layer 22 may include a fluororesin such as polytetrafluoroethylene (PTFE) and polyvinylidene fluoride (PVdF), polyacrylonitrile (PAN), a polyimide resin, an acrylic resin, and a polyolefin resin. With these resins, a cellulose derivative such as carboxymethyl cellulose (CMC) or a salt thereof, polyethylene oxide (PEO), and the like may be used in combination.

### Negative Electrode

The negative electrode 30 has a negative electrode core 31 and a negative electrode mixture layer 32 formed on a surface of the negative electrode core 31. For the negative electrode core 31, a foil of a metal stable within a potential range of the negative electrode 30, such as copper, a film in which such a metal is disposed on a surface layer thereof, and the like may be used. The negative electrode mixture layer 32 includes a negative electrode active material and a binder, and is preferably formed on both surfaces of the negative electrode core 31. In the present embodiment, the core exposed part 33 where a surface of the core is exposed along the longitudinal direction is formed on one end part in the width direction of the negative electrode 30. The positive electrode 20 and the negative electrode 30 are stacked with the separator 40 interposed therebetween so that the core exposed parts 23 and 33 are positioned opposite to the axial direction of the electrode assembly 11. The negative electrode 30 may be produced by, for example, applying a negative electrode mixture slurry including the negative electrode active material, the binder, and the like on the surface of the negative electrode core 31, drying and subsequently compressing the applied film to form the negative electrode mixture layers 32 on both the surfaces of the negative electrode core 31.

The negative electrode mixture layer 32 includes, for example, a carbon-based active material that reversibly occludes and releases lithium ions, as the negative electrode active material. A preferable carbon-based active material is a graphite such as: a natural graphite such as flake graphite, massive graphite, and amorphous graphite; and an artificial graphite such as massive artificial graphite (MAG) and graphitized mesophase-carbon microbead (MCMB). For the negative electrode active material, a Si-based active material composed of at least one of Si and a Si-containing compound may also be used, and the carbon-based active material and the Si-based active material may be used in combination.

An example of the Si-based active material is a compound having a structure in that Si particles are dispersed in a silicon oxide phase (SiO) or a compound having a structure in that Si particles are dispersed in a lithium silicate phase. A preferable SiO has a sea-island structure in that fine Si particles are substantially uniformly dispersed in a matrix of amorphous silicon oxide, and is represented by the general formula SiOₓ (0.5×1.6).

A preferable compound has a sea-island structure in that fine Si particles are substantially uniformly dispersed in a matrix of lithium silicate represented by the general formula Li_{2z}SiO_{(2+z)}(0<z<2).

For the binder included in the negative electrode mixture layer 32, a fluororesin, PAN, a polyimide, an acrylic resin, a polyolefin, and the like may be used similar to that in the positive electrode 20, but styrene-butadiene rubber (SBR) is preferably used. The negative electrode mixture layer 32 preferably further includes CMC or a salt thereof, polyacrylic acid (PAA) or a salt thereof, polyvinyl alcohol (PVA), and the like. Among them, SBR; and CMC or a salt thereof, or PAA or a salt thereof are preferably used in combination.

A median diameter on a volumetric basis (hereinafter, referred to as “D50”) of the carbon-based active material is, for example, 5 μm to 30 μm and preferably 10 μm to 25 μm. The negative electrode mixture layer 32 may include two or more carbon-based active materials having different D50s. The D50, also referred to as a median diameter, means a particle diameter at which a cumulative frequency is 50% from a smaller particle diameter side in a particle size distribution on a volumetric basis. A particle size distribution of the graphite particles may be measured by using a laser diffraction-type particle size distribution measuring device (for example, MT3000II, manufactured by MicrotracBEL Corp.) with water as a dispersion medium.

A BET specific surface area of the carbon-based active material is, for example, 3 m²/g to 8 m²/g, and preferably 4 m²/g to 5 m²/g. The BET specific surface area of the carbon-based active material within the above range, for example, allows the non-aqueous electrolyte liquid easily infiltrate the negative electrode mixture layer 32 to obtain good output characteristics. The BET specific surface area of the carbon-based active material is measured with the BET method by using a conventionally known specific surface area analyzer (for example, Macsorb(R) HM model-1201, manufactured by Mountech Co., Ltd.).

A porosity of the negative electrode mixture layer 32 is preferably 25% to 50%, more preferably 30% to 50%, and particularly preferably 35% to 50%. The porosity of the negative electrode mixture layer 32 within the above range may prevent the occurrence of the minute short-circuit caused by the metal foreign matter 100 with inhibiting the deterioration of the input-output characteristics and the increase in the amount of generation gas during a storage at high temperature. With a porosity of more than 50%, the negative electrode mixture layer 32 is likely to be removed from the surface of the negative electrode core 31. The porosity of the negative electrode mixture layer 32 is calculated by the formula: Porosity (%)=Density of Mixture Layer/True Density. The true density of the negative electrode mixture layer 32 may be measured with a pycnometer.

The negative electrode mixture layer 32 preferably satisfies the above porosity and has a median pore diameter measured with the mercury porosimetry of 1.90 μm or smaller. The median pore diameter means a pore diameter at which a cumulative frequency is 50% from a smaller pore diameter side in a pore distribution. When the negative electrode mixture layer 32 has the same level of the porosity, it is considered that a smaller median pore diameter and a larger number of pores allow the metal ion generated by the oxidative dissolution of the metal foreign matter 100 to enter the negative electrode 30 and to facilitate proceeding the precipitation inside, resulting in inhibition of formation and growth of the dendrite.

A median pore diameter of the negative electrode mixture layer 32 is preferably 1.85 um or smaller, more preferably 1.80 um or smaller, and particularly preferably 1.75 um or smaller. A lower limit of the median pore diameter is not particularly limited, and an example thereof is 1.3 um. The median pore diameter of the negative electrode mixture layer 32 is measured with the mercury porosimetry by using a conventionally known pore size distribution measuring device (for example, AutoPore IV 9500, manufactured by Micromeritics Instrument Corporation).

The porosity and median pore diameter of the negative electrode mixture layer 32 may be regulated within the above preferable range by appropriately change in a type and mixing ratio of components of the negative electrode mixture layer 32, a compression degree of the negative electrode mixture layer 32, and the like. For example, physical properties of the carbon-based active material such as D50, BET specific surface area, and a compressive strength affect on the porosity and pore diameter of the negative electrode mixture layer 32. Typically, using an active material having a particle size distribution with good filling properties and strongly compressing the negative electrode mixture layer 32 likely to reduce the porosity and median pore diameter of the negative electrode mixture layer 32.

### Separator

For the separator 40, a porous sheet having an ion permeation property and an insulation property is used. Specific examples of the porous sheet include a fine porous thin film, a woven fabric, and a nonwoven fabric. As a material for the separator 40, a polyolefin such as polyethylene, polypropylene, and a copolymer of ethylene and an α-olefin, cellulose, and the like are preferable. The separator 40 may have any of a single-layered structure and a multilayered structure. On a surface of the separator 40, a heat-resistant layer including inorganic particles, a heat-resistant layer composed of a highly heat-resistant resin such as an aramid resin, a polyimide, and a polyamideimide, and the like may be formed.

### Non-Aqueous Electrolyte

The non-aqueous electrolyte includes a non-aqueous solvent and an electrolyte salt. For the non-aqueous solvent, esters, ethers, nitriles such as acetonitrile, amides such as dimethylformamide, a mixed solvent of two or more thereof, and the like may be used, for example. The non-aqueous solvent may contain a halogen-substituted solvent in which at least some hydrogens in these solvents are substituted with halogen atoms such as fluorine. Examples of the halogen-substituted solvent include fluorinated cyclic carbonates such as fluoroethylene carbonate (FEC), fluorinated chain carbonates, and fluorinated chain carboxylates such as methyl fluoropropionate (FMP).

Examples of the esters include: cyclic carbonates such as ethylene carbonate (EC), propylene carbonate (PC), and butylene carbonate; chain carbonates such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylates such as y-butyrolactone (GBL) and y-valerolactone (GVL); and chain carboxylates such as methyl acetate, ethyl acetate, propyl acetate, methyl propionate (MP), and ethyl propionate. Among them, at least one selected from the group of EC, EMC, and DMC is preferably used, and a mixed solvent of EC, EMC, and DMC is particularly preferably used.

Examples of the ethers include: cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and a crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

The non-aqueous electrolyte further includes a lithium salt (A) containing an SO₂ bond and an isocyanate compound (B) containing an isocyanate group. As described above, adding the SO₂ bond-containing lithium salt (A) and the isocyanate compound (B) into the non-aqueous electrolyte enhances the oxidative elution of the metal foreign matter 100 on the positive electrode 20 and inhibits the reductive precipitation of the eluted metal ion on the surface of the negative electrode 30. This enhancement and inhibition may inhibit the formation and growth of the dendrite on the surface of the negative electrode 30, and may prevent the occurrence of the minute short-circuit caused by the metal foreign matter 100. The SO₂ bond-containing lithium salt (A) and the isocyanate compound (B) are dissolved in the non-aqueous solvent.

Examples of the SO₂ bond-containing lithium salt (A) includes lithium bis(fluorosulfonyl)imide (LiFSI), lithium bis(trifluoromethanesulfonyl)imide (LiTFSI), lithium fluorosulfonate, and lithium trifluoromethanesulfonate. Among them, a compound containing fluorine is preferable, and LiFSI is particularly preferable.

A concentration of the SO₂ bond-containing lithium salt (A) is preferably 0.1 mass % to 2.5 mass % , more preferably 0.5 mass % to 2.5 mass % , and particularly preferably 1.0 mass % to 2.5 mass % , based on a mass of the non-aqueous electrolyte. The content of the SO₂ bond-containing lithium salt (A) within the above range may prevent the occurrence of the minute short-circuit caused by the metal foreign matter 100 with inhibiting the deterioration of the input-output characteristics and the increase in the amount of generation gas during a storage at high temperature.

The isocyanate compound (B) is preferably a compound containing two or more isocyanate groups in the molecule. Specific examples thereof include hexamethylene diisocyanate (HDI), dicyclohexylmethane diisocyanate, toluene diisocyanate, diphenylmethane diisocyanate, 1,3-bisisocyanatomethylcyclohexane, diisocyanatomethane, 1,3-diisocyanatopropane, 1,4-diisocyanatobutane, 1,5-diisocyanatopentane, 1,6-diisocyanatohexane, 1,7-diisocyanatoheptane, 1,8-diisocyanatooctane, 1,12-diisocyanatododecane, 1,3-diisocyanato-2-fluoropropane, 1,4-diisocyanato-2-butene, 1,4-diisocyanato-2-fluorobutane, 1,4-diisocyanato-2,3-difluorobutane, 1,5-diisocyanato-2-pentene, 1,5-diisocyanato-2-methylpentane, 1,6-diisocyanato-2-hexene, 1,6-diisocyanato-3-hexene, 1,6-diisocyanato-3-fluorohexane, 1,6-diisocyanato-3,4-difluorohexane, 1,3-bis(isocyanatomethyl)cyclohexane, carbonyl diisocyanate, 1,4-diisocyanatobutan-1,4-dione, 1,5-diisocyanatopentan-1,5-dione, diisocyanatobenzene, xylene diisocyanate, ethyldiisocyanatobenzene, trimethyldiisocyanatobenzene, diisocyanatonaphthalene, diisocyanatobiphenyl, and 2,2-bis(isocyanatophenyl)hexafluoropropane. Among them, at least one selected from the group of HDI, dicyclohexylmethane diisocyanate, toluene diisocyanate, diphenylmethane diisocyanate, and 1,3-bisisocyanatomethylcyclohexane is preferable, and HDI is particularly preferable.

A concentration of the isocyanate compound (B) is preferably 0.1 mass % to 8 mass % , more preferably 0.5 mass % to 8 mass % , and particularly preferably 1.5 mass % to 8 mass % , based on a mass of the non-aqueous electrolyte. The content of the isocyanate compound (B) within the above range may prevent the occurrence of the minute short-circuit caused by the metal foreign matter 100 with inhibiting the deterioration of the input-output characteristics and the increase in the amount of generation gas during a storage at high temperature.

The non-aqueous electrolyte preferably includes another lithium salt as the electrolyte salt in addition to the SO₂ bond-containing lithium salt (A). Specific examples of the other lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CnF₂ₙ₊₁)ₓ(1<x<6, n represents 1 or 2), LiB₁₀Cl₁₀, LiCl, LiBr, LiI, lithium chloroborane, a lithium lower aliphatic carboxylate, and borate salts such as Li₂B₄O₇ and Li(B(C₂O₄)F₂). Among them, LiPF₆ is preferable.

### EXAMPLES

Hereinafter, the present disclosure will be further described with Examples, but the present disclosure is not limited to these Examples.

### Example 1

### Production of Positive Electrode

A lithium-transition metal composite oxide represented by the general formula LiNi_{1/3}Co_{1/3}Mn_{1/3}O₂ was used as a positive electrode active material. The positive electrode active material, acetylene black, and polyvinylidene fluoride were mixed at a solid-content mass ratio of 90.3:7:2.7, and N-methyl-2-pyrrolidone (NMP) was used as a dispersion medium to prepare a positive electrode mixture slurry. Then, the positive electrode mixture slurry was applied on both surfaces of a positive electrode core made of aluminum foil excluding a part to which a positive electrode lead was connected, the applied film was dried and compressed, and then cut to a predetermined electrode size to obtain a positive electrode in which the positive electrode mixture layer was formed on both the surfaces of the positive electrode core.

### Production of Negative Electrode

A graphite having a D50 of 1.85 μm and a BET specific surface area of 4.5 m²/g was used as a negative electrode active material. The negative electrode active material, carboxymethyl cellulose (CMC), and styrene-butadiene rubber (SBR) were mixed at a solid-content mass ratio of 99:0.6:0.4, and water was used as a dispersion medium to prepare a negative electrode mixture slurry. Then, the negative electrode mixture slurry was applied on both surfaces of a negative electrode core made of copper foil excluding a part to which a negative electrode lead was connected, the applied film was dried and compressed with a predetermined force, and then cut to a predetermined electrode size to obtain a negative electrode in which the negative electrode mixture layer was formed on both the surfaces of the negative electrode core. A porosity of the negative electrode mixture layer was 31.8%, and a median pore diameter with the mercury porosimetry was 1.85 μm.

### Preparation of Non-Aqueous Electrolyte Liquid

Ethylene carbonate (EC), dimethyl carbonate (DMC), and ethyl methyl carbonate (EMC) were mixed at a volume ratio of 25:35:40 (25° C., 1 atm). Into this mixed solvent, LiFSI was added to be a concentration at 2.5 mass % , and hexamethylene diisocyanate (HDI) was added to be a concentration at 8 mass % , based on a mass of a non-aqueous electrolyte liquid. In addition, LiPF₆ was added to be a concentration at 1.15 M to obtain the non-aqueous electrolyte liquid.

### Production of Test Cell

Each of a test cell for a test of a minute short-circuit caused by an entered metal foreign matter and a test cell for evaluation of performances of output characteristics and gas generation amount was produced by the following method.

### Cell for Test of Minute Short-Circuit

A lead made of aluminum was ultrasonic-welded with the positive electrode cut to the predetermined shape and size, and a lead made of nickel was ultrasonic-welded with the negative electrode cut to the predetermined shape and size. The positive electrode had a rectangular shape with 38 mm in height and 27 mm in width, had a basic part in which the mixture layer was formed on both the surfaces, and had a core exposed part (12 mm in height and 10 mm in width) protruding from one end in the lengthwise direction of the basic part. The negative electrode had a rectangular shape with 41 mm in height and 30 mm in width, had a basic part in which the mixture layer was formed on both the surfaces, and had a core exposed part (10 mm in height and 10 mm in width) protruding from one end in the lengthwise direction of the basic part.

Next, the positive electrode and negative electrode with which the leads were welded were stacked with a multilayered separator including a polypropylene layer and a polyethylene layer interposed therebetween to produce a stacked electrode assembly. In this time, a spherical metal (copper) foreign matter having a diameter of 30 μm was mixed between the positive electrode and the separator. The produced electrode assembly and the non-aqueous electrolyte liquid were housed in an exterior housing body constituted with an aluminum laminate sheet, and an opening was sealed to obtain a cell for a test of minute short-circuit (100 mm in height and 45 mm in width).

### Cell for Evaluation of Performances

A lead made of aluminum was ultrasonic-welded with the positive electrode cut to the predetermined shape and size, and a lead made of nickel was ultrasonic-welded with the negative electrode cut to the predetermined shape and size. The positive electrode was a band-shaped elongate body with 50 mm in width and 230 mm in length, and a core exposed part was formed on one end part in the length direction. The positive electrode lead was welded on one surface of the core exposed part at a position of 7 mm from one end in the length direction of the positive electrode. The negative electrode was a band-shaped elongate body with 52 mm in width and 330 mm in length, and a core exposed part was formed on both end parts in the length direction. The negative electrode lead was welded on one surface of the core exposed part at a position of 18 mm from one end in the length direction of the negative electrode.

Next, the positive electrode and negative electrode with which the leads were welded were spirally wound with a multilayered separator including a polypropylene layer and a polyethylene layer interposed therebetween, and then pressed at a predetermined pressure to produce a flat, wound electrode assembly. In this time, the positive electrode and the negative electrode were wound so that each lead of the positive electrode and negative electrode was positioned on outside of winding. The produced electrode assembly and the non-aqueous electrolyte liquid were housed in an exterior housing body constituted with an aluminum laminate sheet, and an opening was sealed to obtain a cell for evaluation of performances.

### Test of Minute Short-Circuit

The cell for a test of minute short-circuit was charged under a temperature environment at 25° C. to be regulated in a state of charge of SOC (state of charge) 8%. Then, the cell was left to stand at 25° C. for 12 hours, and a voltage drop from the initial standing was monitored to observe a presence of an occurrence of a minute short-circuit. This test was performed on each of 10 test cells and the number of cells that generated a minute short-circuit was counted to determine an occurrence rate of the minute short-circuit.

### Evaluation of Output Characteristics

The cell for evaluation of performances was charged under a temperature environment at 25° C. to be regulated in a state of charge of SOC 50%. Then, the cell was discharged at 25° C. for 10 seconds at each current value of 1 to 36 It to calculate an output resistance (DCIR) with an amount of voltage drop at 10 seconds after the initial discharge.

### Evaluation of Amount of Generation Gas

The cell for evaluation of performances was charged under a temperature environment at 25° C. to be regulated in a state of charge of SOC 50%. Then, the test cell was left to stand at 75° C. for 16 hours to calculate an amount of generation gas with Archimedes method.

### Example 2

Test cells were produced to perform evaluation in the same manner as in Example 1 except that the concentration of LiFSI was changed to 1.0 mass % , and the concentration of HDI was changed to 1.5 mass % , in the preparation of the non-aqueous electrolyte liquid.

### Example 3

Test cells were produced to perform evaluation in the same manner as in Example 2 except that the predetermined pressure during the compression was changed so that the negative electrode mixture layer had a porosity of 36.4% and a median pore diameter of 1.75 μm in the production of the negative electrode.

### Example 4

Test cells were produced to perform evaluation in the same manner as in Example 2 except that the predetermined pressure during the compression was changed so that the negative electrode mixture layer had a porosity of 40.9% and a median pore diameter of 1.65 μm in the production of the negative electrode.

### Comparative Example 1

Test cells were produced to perform evaluation in the same manner as in Example 2 except that no LiFSI was added in the preparation of the non-aqueous electrolyte liquid.

### Comparative Example 2

Test cells were produced to perform evaluation in the same manner as in Example 2 except that no HDI was added in the preparation of the non-aqueous electrolyte liquid.

### Comparative Example 3

Test cells were produced to perform evaluation in the same manner as in Example 3 except that no LiFSI nor HDI was added in the preparation of the non-aqueous electrolyte liquid.

TABLE 1

| | | | | | Evaluation | | |
|---|---|---|---|---|---|---|---|
| | Non-aqueous electrolyte | | Negative electrode | | Occurrence rate of | | Amount of |
| | LiFSI | HDI | Pore diameter | Porosity | minute short-circuit | DCIR | generation gas |
| Comparative | — | 1.5 wt % | 1.85 μm | 31.8% | 70% | 69.4 mΩ | 0.44 mL |
| Example 1 | | | | | | | |
| Comparative | 1.0% | — | 1.85 μm | 31.8% | 90% | 68.0 mΩ | 0.55 mL |
| Example 2 | | | | | | | |
| Comparative | — | — | 1.75 μm | 36.4% | 100% | 70.0 mΩ | 0.45 mL |
| Example 3 | | | | | | | |
| Example 1 | 2.5 wt % | 8 wt % | 1.85 μm | 31.8% | 0% | 72.6 mΩ | 1.10 mL |
| Example 2 | 1.0 wt % | 1.5 wt % | 1.85 μm | 31.8% | 50% | 67.3 mΩ | 0.56 mL |
| Example 3 | 1.0 wt % | 1.5 wt % | 1.75 μm | 36.4% | 0% | 67.2 mΩ | 0.55 mL |
| Example 4 | 1.0 wt % | 1.5 wt % | 1.65 μm | 40.9% | 0% | 67.2 mΩ | 0.57 mL |

As shown in Table 1, any of test cells in Examples has a lower occurrence rate of a minute short-circuit than the test cells in Comparative Examples, and an occurrence of a short circuit caused by the metal foreign matter is remarkably inhibited. In particular, the test cells in Examples 1, 3, and 4, which have an occurrence rate of short circuit of 0%, more certainly prevent the occurrence of a short circuit. The test cells in Examples 3 and 4, which have higher porosities of the negative electrode mixture layer than the test cells in Examples 1 and 2, have excellent output characteristics, smaller amounts of generation gas during a storage at high temperature, and lower occurrence rates of a short circuit.

### REFERENCE SIGNS LIST

10 Non-aqueous electrolyte secondary battery
11 Electrode assembly
12 Positive electrode terminal
13 Negative electrode terminal
14 Exterior housing can
15 Sealing plate
16 Liquid injecting part
17 Gas discharging vent
20 Positive electrode
21 Positive electrode core
22 Positive electrode mixture layer
23, 33 Core exposed part
25 Positive electrode current collector
30 Negative electrode
31 Negative electrode core
32 Negative electrode mixture layer
35 Negative electrode current collector
40 Separator
100 Metal foreign matter

1. A non-aqueous electrolyte secondary battery, comprising:
an electrode assembly in which a positive electrode and a negative electrode are stacked with a separator interposed therebetween; and
a non-aqueous electrolyte, wherein the non-aqueous electrolyte includes a lithium salt (A) containing an SO₂ bond and a compound (B) containing an isocyanate group.

2. The non-aqueous electrolyte secondary battery according to claim 1, wherein a concentration of the lithium salt (A) is 0.1 mass % to 2.5 mass % and a concentration of the compound (B) is 0.1 mass % to 8 mass % based on a mass of the non-aqueous electrolyte.

3. The non-aqueous electrolyte secondary battery according to claim 1, wherein
the negative electrode includes a negative electrode core and a negative electrode mixture layer formed on a surface of the negative electrode core, and
a porosity of the negative electrode mixture layer is 35% to 50%.

4. The non-aqueous electrolyte secondary battery according to claim 3, wherein the negative electrode mixture layer has a median pore diameter measured with mercury porosimetry of 1.75 μm or smaller.
